(19) United States
(12) Patent Application Publication
(10) Pub. No.: US 2003/0234765 A1
(43) Pub. Date: Dec. 25, 2003

(54) Vertical handheld computer mouse

(76) Inventor: Simon Suh, Fullerton, CA (US)

Correspondence Address: Jerry H. Noh, Suite 2716, 3435 Wilshire Blvd, Los Angeles, CA, 90010, US

(21) Appl. No.: 10/180,192

(22) Filed: Jun. 25, 2002

(51) Int. Cl. G09G 5/08

(52) U.S. Cl. 345/163

(57) ABSTRACT

A vertically oriented mouse to be grasped comfortably with the hand in the vertical position with the mouse comprising a planar base member. A handle member contoured to adapt to the inner surface of a user's hand protruding upward from the top surface of the base member with a slight forward slant and a slight inward slant. A first control button being positioned on the upper portion of the front surface of the handle member for corresponding to the end segment of a user's index finger, and a second control button being placed on the top portion of the handle member corresponding for easy access thereto by the last segment of a user's thumb The mouse further comprising thumb rest member protruding sideward from the side surface of the handle member corresponding to the thumb side of the user's hand. A channel extending around the base of the handle member formed protruding concavely into the top surface of the base member.

### FIELD OF THE INVENTION

The present invention relates to manual computer input devices and more particularly to a novel computer mouse made to be gripped by a user's hand essentially in a vertical position.

### DESCRIPTION OF THE PRIOR ART

A computer input device known as the mouse is widely used with nearly all personal computer devices. The mouse is used to move a cursor for pointing to and selecting items and for drawing depending on the software being utilized at the time.

The conventional mouse typically has a horizontal and rounded top surface and is to be used with the user's hand being horizontal over the top surface of the mouse. The user moves the mouse along a horizontal surface to control the movement of the cursor being displayed on the monitor. Also, the conventional mouse has one to three control buttons with at least one button corresponding to the user's index finger and additional buttons corresponding to either or both of the middle and ring fingers. The most commonly used button is that corresponding to the index finger. The horizontal position of the user's hand in using this conventional mouse is not a natural position of the hand in that the user must twist his hand inward approximately ninety degrees to hold the mouse in the horizontal position. With prolonged use especially involving significant movement of the mouse around the horizontal surface, the muscles of the hand, wrist, and forearm become stressed and fatigued. Also, when grasping the mouse in the horizontal position, the bottom surface of the user's wrist frequently touches the horizontal surface. With constant or prolonged use, discomfort can be experienced in the area of the wrist making contact with the horizontal surface.

The natural position of the hand laying on a horizontal surface is for the palm to be substantially vertical with the outer edge of the pinky finger and palm being the area making contact with the horizontal surface. Thus to provide greater comfort, different types of mouse have been developed to allow the user's hand to be substantially in the vertical position in use. One such mouse is taught in U.S. Pat. No. 6,262,715 issued to Sawyer. Sawyer teaches an ergonomic mouse which maintains the user's hand at a large acute angle to the horizontal by a device which includes a base having an upstanding pedestal structure about which the palm and hands of the user extends. Another mouse device issued to Barr in U.S. Pat. No. 5,894,303 teaches a hand holdable mouse with a base, a top surface, and a contoured body around which the user's hand grasps in the vertical position. A disadvantage of these and other types of vertically handheld mouse is found in the lack an effective rest area of the user's thumb when using such a device.

None of the prior art teaches a mouse device as taught in the present invention.

### SUMMARY OF THE INVENTION

The present invention is contrived to overcome the conventional disadvantages. Accordingly, it is an object of the present invention to provide a mouse oriented to be grasped comfortably with the hand in the vertical position. It is another objective of the present invention to provide a mouse having an effective thumb rest for the user's thumb during use. Also, it is an objective of the present invention to provide a mouse having a comfortable rest for the user's outer palm and wrist area.

To achieve the above-described objects, the mouse according to the present invention comprises a planar base member being in the general shape of a kidney having a bottom lobe smaller than the upper lobe The base member has a top surface and a flat bottom surface A handle member contoured to adapt to the inner surface of a user's hand protrudes upward from the top surface of the base member. Furthermore, the handle member has a slight forward slant and a slight inward slant to accommodate the natural position of a user's hand. A first control button is positioned on the upper portion of the front surface of the handle member for operation by the end segment of a user's index finger, and a second control button is placed on the top portion of the handle member for easy operation of the button by the last segment of a user's thumb. A third control button can also be placed adjacent to the second control button.

Furthermore, thumb rest member is provided protruding sideward from the side surface of the handle member. The thumb rest member protrudes horizontally and is of a sufficient length to comfortably accommodate the width of a user's thumb.

The base member also has a channel extending around the base of the handle member. For comfortably receiving the outer edge of a user's hand, the channel as has a concavely curved surface protruding into the top surface.

The mouse also has a means to capture and transfer the movement of the mouse to the computer.

Although the present invention is briefly summarized, the fuller understanding of the invention can be obtained by the following drawings, the detailed description and appended claims.

### BRIEF DESCRIPTION OF THE DRAWINGS

The present invention will be better understood with reference to the accompanying drawings, wherein

FIG. 1 is a top back perspective view illustrating a handheld computer mouse device according to the present invention,

FIG. 1A is a cross sectional view of the device of FIG. 1 cut along the 1A-1A line;

FIG. 2 is a top front perspective view of the present invention;

FIG. 3 is a rear elevational view of the present invention;

FIG. 4 is a front elevational view of the present invention;

FIG. 5 is a side elevational view of the present invention;

FIG. 6 is a bottom perspective view of an alternative embodiment of the present invention not having a thumb rest; and,

FIG. 7 is a bottom plan view of the present invention.

### DETAILED DESCRIPTION OF THE PREFERRED EMBODIMENTS

With reference to the accompanying drawings, an embodiment of the present invention will now be described

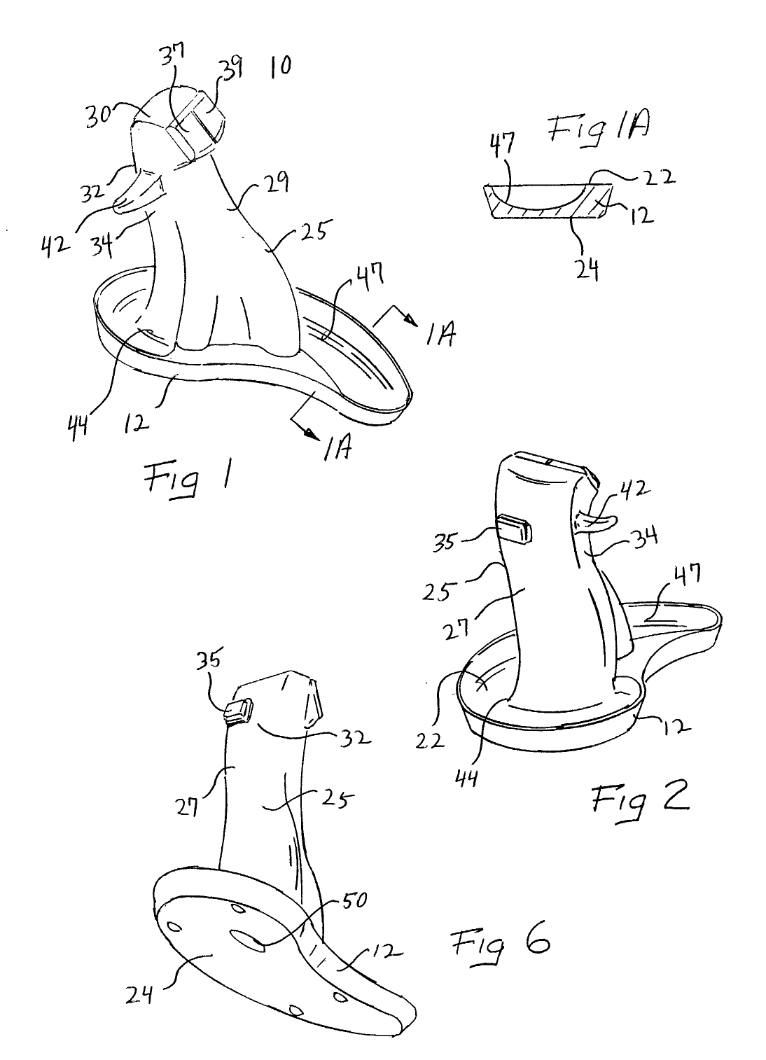

As shown in FIGS. 1-2, the manual computer mouse 10 of the present invention is adapted to be grasped by a user's hand in the vertically upright natural position. While grasping the mouse 10 in this position, the user can move the mouse 10 on a horizontal surface as desired. The mouse has a planar base member 12 being somewhat in the shape of a kidney having a bottom lobe smaller than the top lobe. As best shown in FIG. 7, the base member 12 has a forward circular region 14 and a rear circular region 15. The forward circular region 14 has a first predetermined radius greater than a second predetermined radius of the rear circular region 15. The forward and rear circular regions 14, 15 are joined by a middle region 17 having a curved inner edge 19 and a curved outer edge 20. The inner edge 19 is shorter than the outer edge 20 as shown in the embodiment. A user's hand grasping the mouse 10 would have the palm facing the inner edge 19 and the side of the hand opposite the palm would face the outer edge 20.

In the embodiment illustrated, the second predetermined radius is approximately half the size of the first predetermined radius, and both the inner and outer edges 19, 20 have curvature that is concave relative to the inner direction facing away from a user's palm.

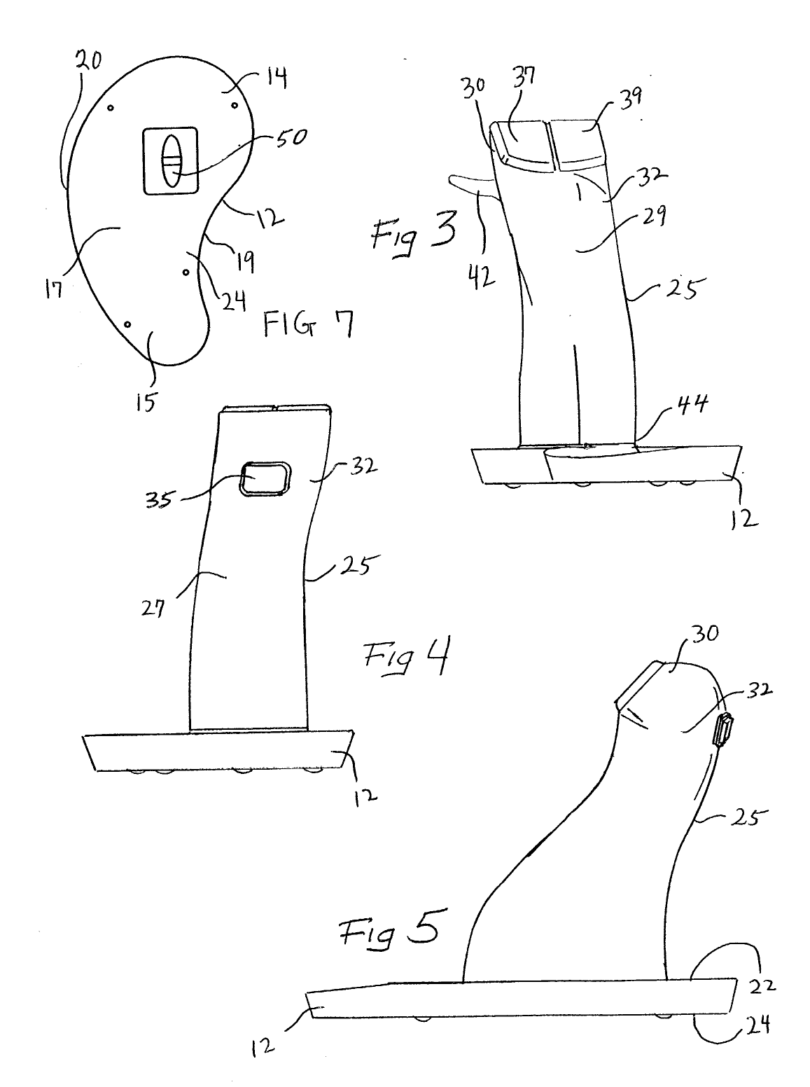

The base member 12 further has a top surface 22 and a bottom surface 24 with the bottom surface 24 being flat. A handle member 25 protrudes upward from the top surface 22 of the base member 12. The handle member 25 is of a predetermined length sufficient to accommodate the width of a user's hand. Also, the handle member 25 is contoured to conform to the inner surface of a user's hand. The handle member 25 has a forward facing front surface 27, a rearward facing rear surface 29, a top portion 30, an upper portion 32, and an inner side surface 34 facing the inner direction away from a user's palm. Furthermore, the handle member 25 has a forward slant ranging from thirteen to seventeen degrees from the vertical position and a sideward slat towards the inner direction ranging from four to six degrees from the vertical position. In the embodiment shown in FIGS. 1-6, the forward slant is fifteen degrees from the vertical position and the sideward slant is 5 degrees from the vertical position.

For functioning as an electronic input device for a computer, the mouse can have one to three control buttons. A first control button 35 is positioned on the upper portion of the front surface of the handle member 25 for operation by the end segment of a user's index finger. A second control button 37 can be placed on the top portion of the handle member 25 for easy operation by being positioned to correspond to the end segment of the user's thumb. A third control button 39 can also be placed adjacent to the second control button 37.

For providing a resting area for the thumb, a thumb rest member 42 is provided protruding sideward from the inner side surface 34 of the handle member 25. The thumb rest member 42 protrudes horizontally and is of a sufficient length to accommodate the width of a user's thumb.

As best illustrated in FIGS. 1 and 2, the base member further has an elongated channel 47 extending around the base 44 of the handle member 25. The channel 47 as shown in FIG. 1A has a concavely curved surface protruding into the top surface 22 for adaptation to the outer edge of the user's hand. The channel 47 which corresponds to the curvature of the base member extends around the base member at least a predetermined distance sufficient to accommodate the outer surface of a user's hand from the wrist to the tip of the pinky finger. In the embodiment of the present invention shown, the channel 47 extends around the entire perimeter of the base member but for the area adjacent the inner edge as this area is normally not in contact with a user's hand.

The present invention can utilize one of the two well-known means to capture and transfer the movement of the mouse to the computer. One known means is a ball placed within the mouse protruding from the bottom surface thereof and mounted for rotational movement. As the mouse is moved horizontally along a surface, the ball rolls with the mouse and transmits it movement to wheels coupled therewith. The data on the movement of the ball is electrically transmitted by a connecting wire or by well-known wireless remote technology to the computer. Another well-known means utilizes optical sensing circuitry as developed by Agilent Technologies. This technology replaces the ball with a light sensitive sensor which shines through a lens provided on the bottom surface of the mouse and onto the surface for tracking the movement of the mouse relative to the surface. The embodiment illustrated in FIGS. 6 and 7 shows the present invention utilizing the optical sensing circuitry housed in the base member and handle member. The lens 50 is shown on the bottom surface of the base member.

Although the present invention has been described in considerable detail with reference to certain preferred versions thereof, other versions are possible by converting the aforementioned construction. Also, it should be known that a right-handed version of the mouse has been illustrated in FIGS. 1-7. A left-handed version of the mouse illustrated herein can be made by providing a mirror image of the embodiment shown. Therefore, the scope of the invention shall not be limited by the specification specified above and the appended claims.

What is claimed is:

1. A manual computer mouse, said mouse comprising:
a base member having a top surface and a bottom surface, said bottom surface being flat for smooth movement on a horizontally flat surface;
a handle member protruding upward from said top surface of said base member, said handle member having a forward facing front surface and a rearward facing rear surface;
a first control button disposed on an upper portion of the front surface of said handle member, said first control button being positioned to correspond to the position of the end portion of a user's index finger,
a second control button disposed on a top portion of said handle member, said second control button being positioned to correspond to the position of the user's thumb;
said base member having a channel extending around the base of the handle member, said channel having a concavely curved surface protruding into said top surface;
whereby when a user's hand is wrapped on said handle, said channel extends around said base member at least a predetermined distance sufficient to accommodate the outer surface of the user's hand from the wrist to the tip of the pinky finger.

2. A manual computer mouse as described in claim 1 further comprising a thumb rest member protruding from an upper portion of a side surface of the handle member, said thumb rest member protruding horizontally and being of a predetermined length sufficient to accommodate the width of a user's thumb.

3. A manual computer mouse as described in claim 1 wherein said handle member has a slight forward slant.

4. A manual computer mouse as described in claim 3 wherein said handle member has a forward slant ranging from thirteen to seventeen degrees from the vertical position.

5. A manual computer mouse as described in claim 1 wherein said handle member has a slight sideward slant towards an inner direction away from a user's palm.

6. A manual computer mouse as described in claim 5 wherein said handle member has a slight sideward slant ranging from four to six degrees towards the inner direction from the vertical position.

7. A manual computer mouse as described in claim 1 further comprising a third control button adjacent said second control button.

8. A manual computer mouse adapted to be grasped by a user's hand in a vertically upright position to move said mouse on a horizontal surface, said mouse comprising:
a base member;
said base member comprising a forward circular region of a first predetermined radius and a rear circular region of a second predetermined radius, said second predetermined radius being less than the first predetermined radius, said forward circular region and rear circular region being connected by a middle region having a curved inner edge and a curved outer edge, said inner edge being shorter than said outer edge, whereby the palm of a user's hand faces the inner edge and the side of a user's hand opposite the palm faces the outer edge;
said base member having a top surface and a bottom surface, said bottom surface being flat for smooth movement on a horizontally flat surface;
a handle member protruding upward from said top surface of said base member, said handle member having a forward facing front surface and a rearward facing rear surface and an inner side surface facing an inner direction away from the user's palm;
a first control button disposed on an upper portion of the front surface of said handle member, said first control button being positioned to correspond to the position of the end segment of a user's index finger; and,
a second control button disposed on a top portion of said handle member, said second control button being positioned to correspond to the position of the user's thumb.

9. A manual computer mouse as described in claim 8 wherein said base member has a channel extending around the base of the handle member, said channel having a concavely curved surface protruding into said top surface;
whereby when a user's hand is wrapped on said handle, said channel extends around said base member at least a predetermined distance sufficient to accommodate the outer surface of a user's hand from the wrist to the tip of the pinky finger.

10. A manual computer mouse as described in claim 8 further comprising a thumb rest member protruding sideward from the inner side surface of the handle member, said thumb rest member protruding horizontally and being of a predetermined length sufficient to accommodate the width of a user's thumb.

11. A manual computer mouse as described in claim 8 wherein said handle member has a slight forward slant and a slight sideward slat towards the inner direction.

12. A manual computer mouse as described in claim 11 wherein said handle member has a forward slant ranging from thirteen to seventeen degrees from the vertical position, and said handle member has a sideward slant ranging from four to six degrees towards the inner direction from the vertical position.

13. A manual computer mouse as described in claim 8 further comprising a third control button adjacent said second control button.
